(19) United States
(12) Patent Application Publication
(10) Pub. No.: US 2018/0115924 A1
(43) Pub. Date: Apr. 26, 2018

(54) Dynamic Exchange Of Wireless Communication Services

(71) Applicant: NOKIA SOLUTIONS AND NETWORKS OY, Espoo (FI)

(72) Inventors: John HARRIS, Whitefish Bay, WI (US); Maximilian RIEGEL, Nuernberg (DE)

(21) Appl. No.: 15/299,354

(22) Filed: Oct. 20, 2016

(51) Int. Cl. H04W 28/18; H04W 8/00; H04W 4/24; H04W 8/14; H04W 28/24

(52) U.S. Cl. CPC H04W 28/18; H04W 8/005; H04W 88/04; H04W 8/14; H04W 28/24; H04W 4/24

(57) ABSTRACT

In a general aspect, a method can include determining that a first user device in a wireless network will offer wireless communications services to one or more other user devices; determining mobility information for the first user device; and sending a wireless communications service offer message that offers to provide a wireless communications service to other user devices. The wireless communications service offer message can indicate one or more service parameters including at least the mobility information of the first user device and a price for one or more service levels of wireless communications services. The method can further include providing, by the first user device, wireless communications services to a second user device after the first user device and the second user device have confirmed at least the price for a service level of communications services to be provided to the second user device.

### TECHNICAL FIELD

This description relates to communications, and in particular, to providing use of wireless communication services of one device to other devices.

### BACKGROUND

A communication system may be a facility that enables communication between two or more nodes or devices, such as fixed or mobile communication devices. Signals can be carried on wired or wireless carriers.

An example of a cellular communication system is an architecture that is being standardized by the 3^{rd} Generation Partnership Project (3GPP). A recent development in this field is often referred to as the long-term evolution (LTE) of the Universal Mobile Telecommunications System (UMTS) radio-access technology. S-UTRA (evolved UMTS Terrestrial Radio Access) is the air interface of 3GPP's Long Term Evolution (LTE) upgrade path for mobile networks. In LTE, base stations or access points (APs), which are referred to as enhanced Node AP (eNBs), provide wireless access within a coverage area or cell. In LTE, mobile devices, user devices or mobile stations are referred to as user equipments (UEs).

In some wireless networks, user devices or UEs may have limited resources. Such resources may include battery capacity, data communication speed, data bandwidth availability, among other resources.

### SUMMARY

In a general aspect, a method can include determining, by a first user device in a wireless network, that the first user device will offer wireless communications services to one or more other user devices; determining, by the first user device, mobility information for the first user device; and sending, by the first user device, a wireless communications service offer message that offers to provide a wireless communications service to other user devices. The wireless communications service offer message can indicate one or more service parameters including at least the mobility information of the first user device and a price for one or more service levels of wireless communications services. The method can further include providing, by the first user device, wireless communications services to a second user device after the first user device and the second user device have confirmed at least the price for a service level of communications services to be provided to the second user device.

Implementations can include one or more of the following details. For example, the determining, by the first user device, that the first user device will offer wireless communications services to one or more other user devices can include at least one of confirming that the first user device has a connection established to a network node; confirming that the first user device is performing a transfer with the network node; confirming that a link quality, signal strength or a data rate of a wireless link between the first user device and the network node is greater than a threshold; and determining that an amount of charge on a battery for the first user device is greater than a threshold.

The mobility information can include at least one of a location of the first user device; an expected duration of time the first user device will remain at the location; a speed of the first user device; a mobility state of the first user device; a direction of travel or route of the first user device; and a mode of travel of the first user device.

The service level for at least one of uplink communications and downlink communications can be indicated by at least one of a data rate; a quality of service (QoS); and a link quality.

The wireless communications services can include at least one of forwarding data received from the second user device to a network node; and forwarding data received from the network node to the second user device.

The providing wireless communication services can include receiving, by the first user device from the second user device, a wireless communications reply message that indicates that the second user device accepts the service parameters indicated by the wireless communications service offer message; establishing, by the first user device, a connection between the first user device and the second user device; and providing, by the first user device, the wireless communications services, including relaying, by the first user device via wireless communications, data between the second user device and a network node in at least one of an uplink direction and a downlink direction. The wireless communications reply message can indicate a selected service level for the communications services of a plurality of service levels indicated by the wireless communications service offer message.

The one or more service parameters can include one or more of a time duration during which the first user device is offering wireless communications services; an indication whether the first user device will modify its mobility information to provide the offered wireless communication services; an indication of whether the first user device can cache information for the second user device; an indication that the offered wireless communications services are associated with a transportation service; and one or more security-related parameters or security-related configuration information. The one or more service parameters can be based on a wireless communications service offer message from a third user device.

The one or more service levels of wireless communications services can include a first bit rate that can be provided during a first time interval and a second bit rate that can be provided during a second time interval, the second time interval being a different time interval than the first time interval.

The providing wireless communication services can include receiving, by the first user device from the second user device, a wireless communications service reply message that indicates a new service parameter or a change to one of the service parameters indicated by the wireless communication service offer message; sending, by the first user device to the second user device, a wireless communications service confirmation message that indicates that the first user device will provide the wireless communication service to the second user device in accordance with the service parameters indicated by the wireless communications service reply message; and providing, by the first user device, the wireless communications services to the second user device.

The wireless communications service offer message can include one of a broadcast message and a unicast message. The wireless communications service offer message can be responsive to a query message from the second user device.

The providing the wireless communications services to the second user device can include automatically providing the wireless communications services to the second user device without user intervention.

The method can include verifying, at least once during the providing the wireless communications services to the second user device, whether a payment for at least a portion of the wireless communications services provided to the second user device has been made; and, if the payment has not been made, ceasing to provide the wireless communications services to the second user device. The method can include, if the payment has been made, continuing to provide the wireless communications services.

In another general aspect, a method can include sending, by a first user device in a wireless network, a wireless communications service request message that requests wireless communications service from another user device. The wireless communications service request message can indicate one or more service parameters including at least a price for one or more service levels. The method can also include receiving, by the first user device from a second user device, a wireless communications service reply message and obtaining, by the first user device from the second user device, wireless communications services after the first user device and the second user device have confirmed at least the price for a service level of communications services to be provided by the second user device to the first user device.

Implementations can include one or more of the following features. For example, the wireless communications service request message includes one of a broadcast message and a unicast message.

The one or more service parameters can include one or more of a time duration during which the first user device is requesting wireless communications services; an indication whether the first user device will modify its mobility information to receive offered wireless communication services; and one or more security-related parameters or security-related configuration information.

The method can include, prior to sending the wireless communications service request message, determining, by the first user device, that the first user device will request wireless communications services from at least one other user device. The determining, by the first user device, that the first user device will request wireless communications services from at least one other user device can include at least one of determining that a link quality, signal strength or a data rate of a wireless link between the first user device and a network node is less than a threshold; determining that an amount of data bandwidth available to the first user device is below a threshold; and determining that an amount of charge on a battery for the first user device is less than a threshold.

The one or more service parameters can include one or more of; mobility information for the first user device; a time duration during which the first user device is requesting wireless communications services; and one or more security-related parameters or security-related configuration information.

The obtaining the wireless communications services can include automatically obtaining the wireless communications services without user intervention.

In another general aspect, a wireless device can include at least one processor and at least one memory including computer instructions. The instructions, when executed by the at least one processor, can cause the wireless device to determine that the wireless device will offer wireless communications services to one or more other wireless devices; determine mobility information for the wireless device; and send a wireless communications service offer message that offers to provide a wireless communications service to the one or more other wireless devices. The wireless communications service offer message can indicate one or more service parameters including at least the mobility information of the wireless device and a price for one or more service levels of wireless communications services. The instructions, when executed by the at least one processor, can further cause the wireless device to provide wireless communications services to a wireless device of the one or more other wireless devices after the wireless device and the wireless device of the one or more other wireless devices have confirmed at least the price for a service level of communications services to be provided to the wireless device of the one or more other wireless devices.

In another general aspect, a wireless device can include at least one processor and at least one memory including computer instructions. The instructions, when executed by the at least one processor, can cause the wireless device to send, in a wireless network, a wireless communications service request message that requests wireless communications service from another wireless device. The wireless communications service request message can indicate one or more service parameters including at least a price for one or more service levels. The instructions, when executed by the at least one processor, can further cause the wireless device to receive, from the another wireless device, a wireless communications service reply message; and obtain, from the another wireless device, wireless communications services after the wireless device and the another wireless device have confirmed at least the price for a service level of communications services to be provided by the another wireless device to the wireless device.

The details of one or more examples of implementations are set forth in the accompanying drawings and the description below. Other features will be apparent from the description and drawings, and from the claims.

### BRIEF DESCRIPTION OF THE DRAWINGS

FIG. 1 is a block diagram of a wireless network according to an implementation.

FIG. 2A is a flowchart illustrating a method for providing use of wireless communication resources of one device (user device or UE) to another device, according to an implementation.

FIG. 2B is flowchart illustrating a method for providing use of wireless communication resources of one device to another device that can be implemented in conjunction with the method of FIG. 2A, according to an implementation.

FIG. 3 is a flowchart illustrating a method for requesting and obtaining, by a first device, use of wireless communication services of a second device according to an implementation.

FIG. 4 is a block diagram illustrating a system which can be used to dynamically exchange wireless communication resources, according to an implementation.

FIG. 5 is a diagram illustrating signaling corresponding with dynamic exchange of wireless communication services initiated by a provider device (provider UE, provider user device, etc.), according to an implementation.

FIG. 6 is a diagram illustrating signaling corresponding with dynamic exchange of wireless communication services initiated by a consumer device (consumer UE, consumer user device, etc.), according to an implementation.

FIG. 7 is a flowchart illustrating a method for requesting and/or obtaining use of wireless communications services by one user device from another user device, according to an implementation.

FIG. 8 is a flowchart illustrating a method for offering and/or providing use of wireless communications services by one user device to another user device, according to an implementation.

FIG. 9 is a block diagram of a node or wireless station (e.g., network device, base station/access point or mobile station/user device/UE), according to an implementation.

### DETAILED DESCRIPTION

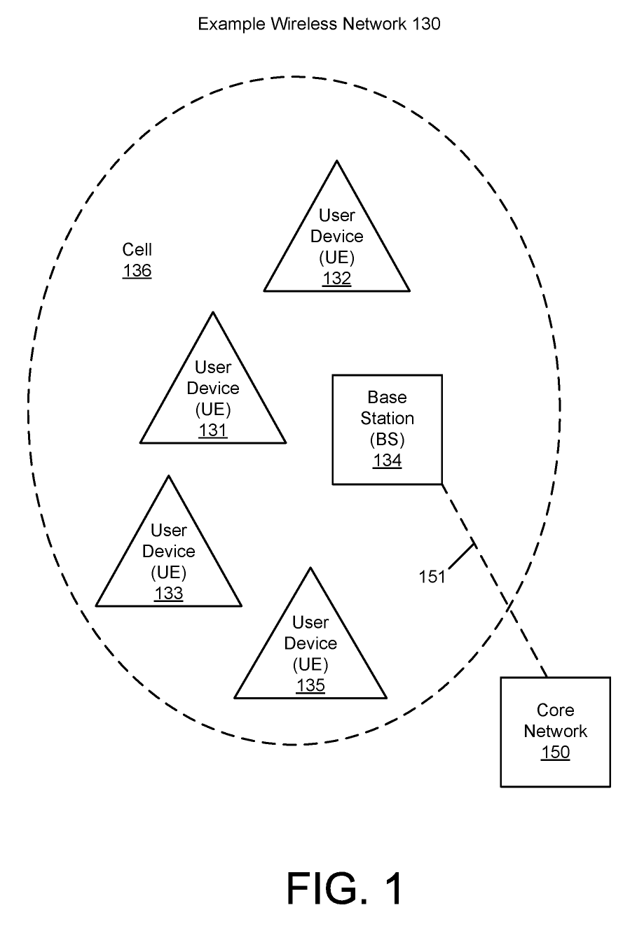

FIG. 1 is a block diagram of a wireless network 130 according to an example implementation. In the wireless network 130 of FIG. 1, user devices 131, 132, 133 and 135, which may also be referred to as mobile stations (MSs), user devices (e.g., consumer user devices and/or provider user devices) or user equipment (UEs), may be connected (and in communication) with a base station (BS) 134, which may also be referred to as an access point (AP), an enhanced Node B (eNB) or a network node. At least part of the functionalities of an access point (AP), base station (BS) or (e)Node B (eNB) may be also be carried out by any node, server or host which may be operably coupled to a transceiver, such as a remote radio head. BS (or AP) 134 provides wireless coverage within a cell 136, including to user devices 131, 132, 133 and 135. Although only four user devices are shown as being connected or attached to BS 134, any number of user devices may be provided. BS 134 is also connected to a core network 150 via a S1 interface 151. This is merely one simple example of a wireless network, and others may be used.

A user device (user terminal, user equipment (UE) or mobile station) may refer to a portable computing device that includes wireless mobile communication devices operating with or without a subscriber identification module (SIM), including, but not limited to, the following types of devices: a mobile station (MS), a mobile phone, a cell phone, a smartphone, a personal digital assistant (PDA), a handset, a device using a wireless modem (alarm or measurement device, etc.), a laptop and/or touch screen computer, a tablet, a phablet, a game console, a notebook, and a multimedia device, as examples. It should be appreciated that a user device may also be a nearly exclusive uplink only device, of which an example is a camera or video camera loading images or video clips to a network.

By way of illustrative example, the various example implementations or techniques described herein may be applied to various user devices, such as machine type communication (MTC) user devices, enhanced machine type communication (eMTC) user devices, Internet of Things (IoT) user devices, and/or narrowband IoT user devices. IoT may refer to an ever-growing group of objects that may have Internet or network connectivity, so that these objects may send information to and receive information from other network devices. For example, many sensor type applications or devices may monitor a physical condition or a status, and may send a report to a server or other network device, e.g., when an event occurs. Machine Type Communications (MTC, or Machine to Machine communications) may, for example, be characterized by fully automatic data generation, exchange, processing and actuation among intelligent machines, with or without intervention of humans.

Also, in an example implementation, a user device or UE may be a UE/user device with ultra-reliable low latency communications (URLLC) applications. A cell (or cells) may include a number of user devices connected to the cell, including user devices of different types or different categories, e.g., including the categories of MTC, NB-IoT, URLLC, or other UE category.

In LTE (as an example), core network 150 may be referred to as Evolved Packet Core (EPC), which may include a mobility management entity (MME) which may handle or assist with mobility/handover of user devices between BSs, one or more gateways that may forward data and control signals between the BSs and packet data networks or the Internet, and other control functions or blocks.

The various example implementations may be applied to a wide variety of wireless technologies or wireless networks, such as LTE, LTE-A, 5G, cmWave, and/or mmWave band networks, IoT, MTC, eMTC, URLLC, etc., or any other wireless network or wireless technology. These example networks or technologies are provided only as illustrative examples, and the various example implementations may be applied to any wireless technology/wireless network.

As noted above, user devices, such as the user devices 131-135 in FIG. 1, may have one or more limited resources. Such resources may include battery capacity, data communication speed, data bandwidth availability, among other resources. For instance, in FIG. 1, user device 131 could be a wearable device, such as a watch, that has limited battery capacity, may not have high speed cellular data capability (e.g., no 5G and/or LTE service), and/or other limited resources. In other instances, user devices may have limited resources due to other factors, such as a low battery charge, a limitation on data bandwidth as part of a contract with a cellular network operator, limited or no cellular data connectivity due to poor signal reception or other factors, such as being outside of a compatible network (e.g., international travel, etc.), among other limitations.

In such situations, using the techniques described herein, user devices, such as the user devices 131-135 of the wireless network 130 illustrated in FIG. 1, can dynamically exchange wireless communication services. For instance, the user device 131 could discover and negotiate use of wireless communications services of the user device 135 to upload and/or download data from the Internet through the core network 150. Such approaches can save battery power in user devices that utilize wireless communications services of other user devices, or allow user devices to accomplish tasks that they would be unable to complete with obtaining use of wireless communication services from other user devices.

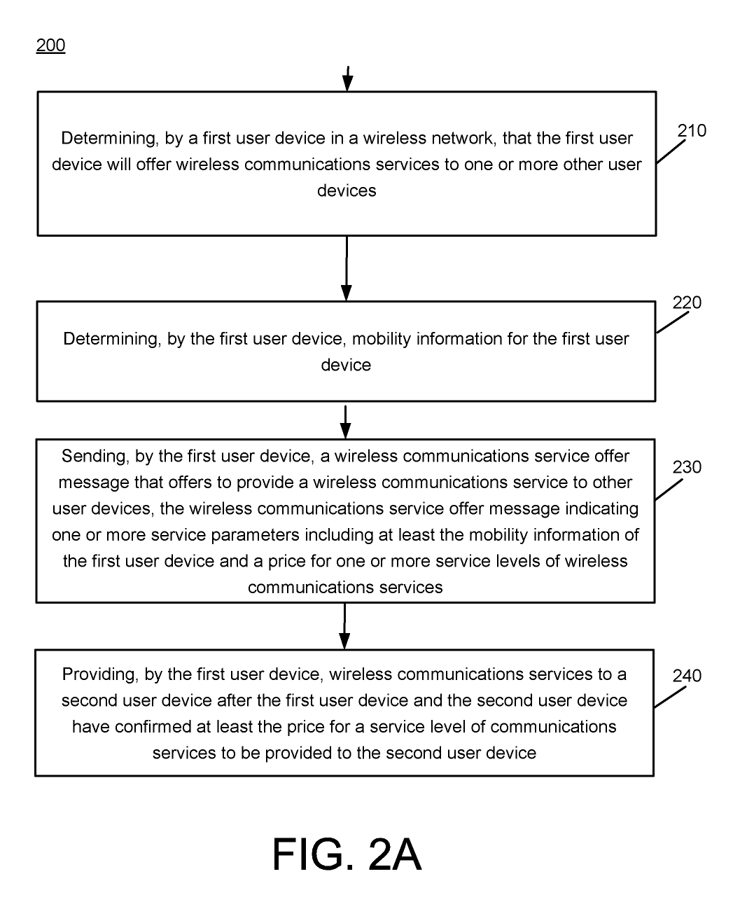

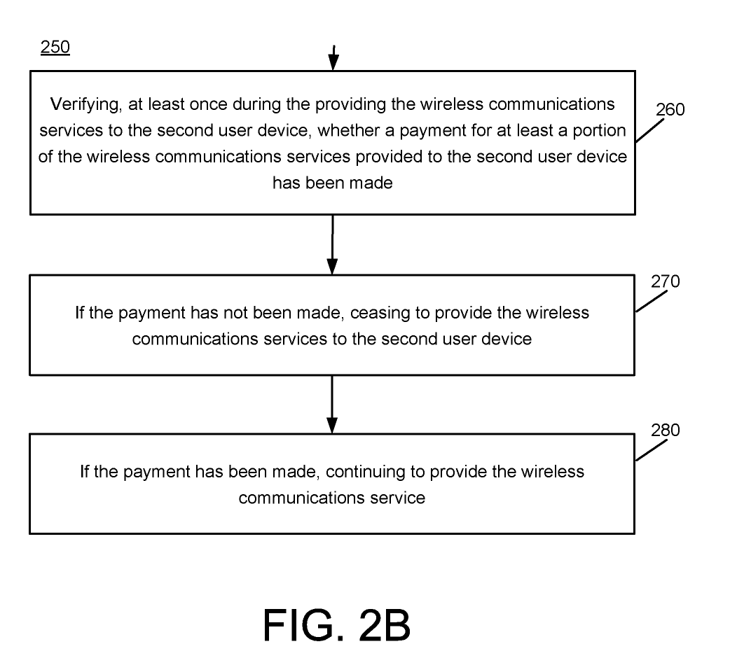

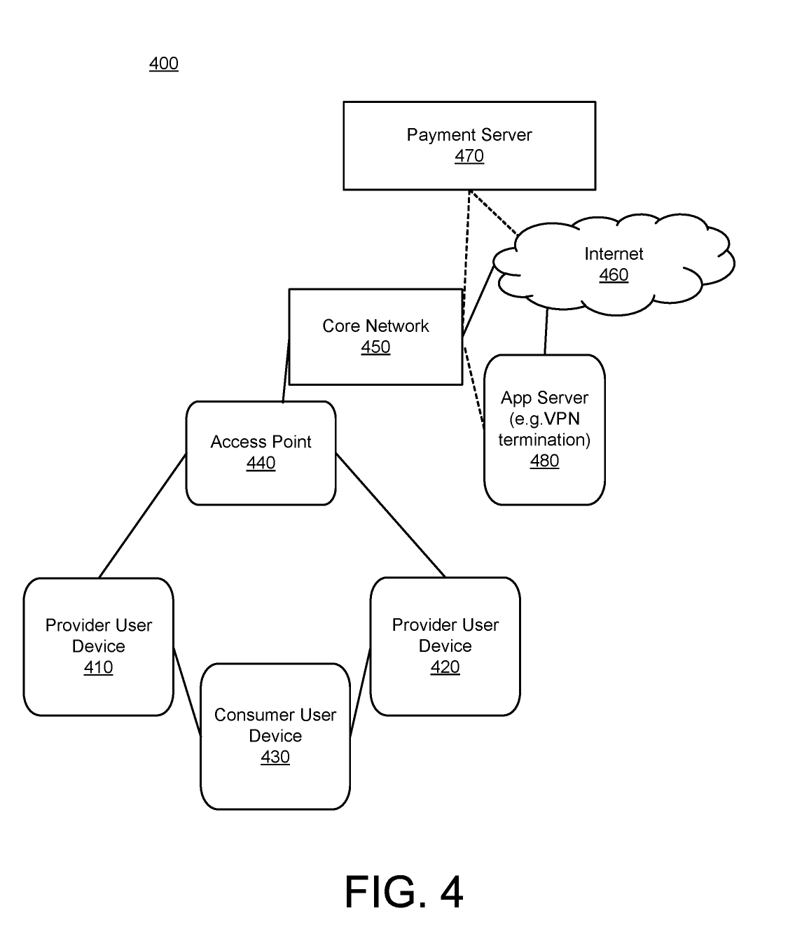

FIG. 2A is a flowchart illustrating a method 200 for providing use (dynamic exchange) of wireless communication resources of one device (user device or UE) to another device, according to an implementation. The method 100 can be implemented, for example, in the wireless network 130 shown in FIG. 1, or in the system 400 shown in FIG. 4, which is described below. Alternatively, the method 200 can be implemented in networks or systems having other configurations.

As shown in FIG. 2, the method 200 includes, at block 210, determining, by a first user device in a wireless network, that the first user device will offer wireless communications services to one or more other user devices. In this example, the first user device can be referred to as a provider user device (provider device, provider UE, etc.), while the other user devices (to which wireless communications services are being offered) can be referred to as consumer devices.

At block 220, the method 200 includes determining, by the first user device, mobility information for the first user device. At block 230, the method 200 includes sending, by the first user device, a wireless communications service offer message that offers to provide a wireless communications service to other user devices. The wireless communications service offer message of block 230 can indicate one or more service parameters, including at least the mobility information of the first user device and a price for one or more service levels of wireless communications services. At block 240, the method 200 includes providing, by the first user device, wireless communications services to a second user device after the first user device and the second user device have confirmed at least the price for a particular service level of communications services to be provided to the second user device. In this example, as noted above, the second user device can be referred to as a consumer user device (consumer device, consumer UE, etc.). In certain implementation, user devices can be configured to operate as both a consumer device and a provider device.

In the method 200, the determining, by the first user (provider) device, that the provider device will offer wireless communications services to one or more other user (consumer) devices at block 210 can include one or more of the following. The offered wireless communications services can include at least one of forwarding data received from the second user (consumer) device to a network node and forwarding data received from the network node to the consumer device. The network node can be implemented as, for example, an access point, a base station, or other network infrastructure node, such as those described herein.

The determining at block 210 of the method 200 can include confirming that the first user device has a connection established to a network node (e.g., a node with Internet connectivity). The determining at block 210 could include confirming that the first user device is performing a transfer with the network node (e.g., to or from the Internet or other network). The determining at block 210 could also include confirming that a link quality, signal strength or a data rate of a wireless link between the first user device and the network node is greater than a threshold. The determining at block 210 could further include determining that an amount of charge on a battery for the first user device is greater than a threshold.

At block 220 of the method 200, the mobility information can include at least one of a location of the provider device; an expected duration of time the provider device will remain at the location; a speed of the provider device; a mobility state of the provider device; a direction of travel or route of the provider device; and a mode of travel of the provider device. The location of the provider device can include a global positioning system (GPS) location, a street address, latitude and longitude, etc. The mobility state can, for example, be indicated as low (e.g., stationary or near stationary), medium, high, and/or may be indicted using categories for different speeds and or velocities. The mode of travel could be indicated as pedestrian, bus, train, airplane, passenger vehicle, ride share vehicle, etc.

At block 230, the wireless communications service offer message can be one of a broadcast (multicast) message and a unicast message The wireless communications service offer message of block 230 can be responsive to a query message from the consumer device requesting an exchange of wireless communications services (e.g., for payment). Example messages that can be used by provider devices and consumer devices to facilitate dynamic exchange of wireless communication services are described below.

Also at block 230, the one or more service parameters can be based on offered service parameters in a wireless communications service offer message from a third user device (e.g., a second provider device). For example, the first user device may modify its offered service levels and respective pricing for those service levels based on services and pricing being offered by the second provider device (or other provider devices that are in proximity to the first user device and the second user device).

At block 230 of the method 200, the service level(s) for at least one of uplink communications and downlink communications can be indicated by at least one of a data rate, a quality of service (QoS) and a link quality. The one of more service parameters at block 230 of the method 200 can include a time duration during which the first user device is offering wireless communications services, which can be associated with a specific location or mobility of the provider device, e.g., can be associated with the mobility information of block 220. The service parameters of block 230 could also include one or more of an indication whether the first user device will modify its mobility information to provide the offered wireless communication services, an indication of whether the first user device can cache information for the second user device, and an indication that the offered wireless communications services are associated with a transportation service, such as a ride share service, public transportation, etc.). The service parameters of block 230 can also include one or more security-related parameters, or security-related configuration information associated with the offered wireless communications services.

At block 230, the one or more service levels of wireless communication services can include a first bit rate that can be provided during a first time interval and a second bit rate that can be provided during a second time interval, the second time interval being a different time interval than the first time interval.

At block 240 of the method 200, providing the wireless communication services to the consumer device can include receiving, by the provider device from the consumer device, a wireless communications reply message that indicates that the consumer device accepts the service parameters indicated by the wireless communications service offer message. In such approaches, the wireless communications reply message can indicate a selected service level for the communications services of a plurality of service levels indicated by the wireless communications service offer message.

In other implementations, the wireless communications reply message can include a counteroffer to the wireless communications service offer message, which the provider device can accept or, alternatively, can send a second counteroffer to the consumer device. In certain implementations, additional counteroffers can be made by the consumer device and/or the provider device. The negotiation of service parameters and providing wireless communications services from the provider device to the consumer device can be automatically performed (e.g., without user intervention). For instance, the negotiation of service parameters can be performed by respective applications on the provider device and consumer device and/or based on configuration information for dynamic exchange of wireless communications service, where the configuration information can be defined (e.g., by a user) prior to negotiation of service parameters for providing wireless communications services using the method 200.

In an example implementation, the providing at block 240 of the method 200 can include receiving, by the provider (first) user device from the consumer (second) user device, a wireless communications service reply message that indicates a new service parameter or a change to one of the service parameters indicated by the wireless communication service offer message. In response to the wireless communications service reply message (e.g., if agreement on service parameters has been reached), the provider device can send, to the consumer device, a wireless communications service confirmation message that indicates that the provider device will provide wireless communications services to the consumer device in accordance with the service parameters indicated by the wireless communications service reply message. The provider device can then provide the wireless communications services to the consumer device based on the agreed service parameters.

Once service parameters have been agreed to by the provider device and the consumer device, the providing at block 240 of the method 200 can include establishing, by the provider device, a connection between the provider device and the consumer device. The connection between the provider device and the consumer device can be a wireless connection, such as a WiFi connection, a BLUETOOTH connection, or other data connection over which information (data) can be exchanged (e.g., locally exchanged) between the provider device and the consumer device.

The providing at block 240 can further include (e.g. after establishing the connection between the provider device and the consumer device) relaying, by the provider device via wireless communications, data between the consumer device and a network node in at least one of an uplink direction and a downlink direction, where the uplink direction is from the consumer (second) user device to the provider (first) user device, and the downlink direction is from the provider device to the consumer device.

FIG. 2B is flowchart illustrating a method 250 for providing use (dynamic exchange) of wireless communication resources of one device (a provider device) to another device (a consumer device) that can be implemented in conjunction with the method 200 of FIG. 2A, according to an implementation. As shown in FIG. 2B, the method 250 includes, at block 260, verifying, at least once during the providing the wireless communications services to the consumer device (at block 240), whether a payment for at least a portion of the wireless communications services provided to the consumer device has been made.

At block 270, if the payment has not been made, the method 250 includes ceasing to provide the wireless communications services to the consumer device. Further, if payment is not made, the provider device can note the non-payment and take further action, such as refusing to provide wireless communication services to the consumer device, sending notices for payment, etc.

At block 270, if the payment has been made, the method 250 includes continuing to provide the wireless communications services to the consumer device per the accepted offer between the provider device and the consumer device. In an example implementation, payment for use of wireless communications services of the provider device by the consumer device can be made incrementally, such as payment for each fixed amount of data bandwidth used, each fixed period of time that provided wireless communications services are used and/or each fixed percentage of battery capacity of provider device used while providing services to the consumer device, as some examples. Payment for use of wireless communications services of the provider device by the consumer device can be made in a number of ways, such as using a payment service implemented on a server, through an account with an owner of the provider device, through a network operator account, and so forth.

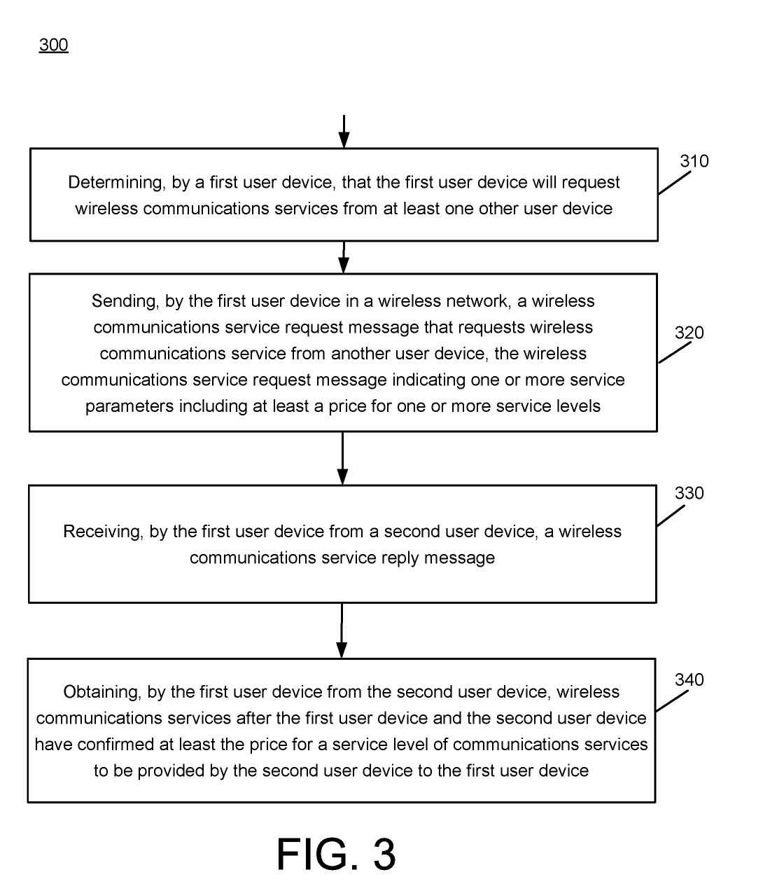

FIG. 3 is a flowchart illustrating a method 300 for requesting and obtaining, by a first device (a consumer device), use of wireless communication services of a second device (a provider device) according to an implementation. As with the methods 200 and 250, the method 300 can be implemented, for example, in the wireless network 130 shown in FIG. 1, or in the system 400 shown in FIG. 4, which is described below. Alternatively, the method 300 can be implemented in networks or systems having other configurations.

As shown in FIG. 3, the method 300 includes, at block 310, determining, by a first user device (a consumer device), that the consumer device will request wireless communications services from at least one other user device. The method 300 also includes, at block 320, sending, by a first user device (a consumer device) in a wireless network, a wireless communications service request message that requests wireless communications services from another user device (e.g., from a provider device). The wireless communications service request message at block 320 can indicate one or more service parameters including at least a price for one or more service levels.

At block 330, the method 300 includes receiving, by the consumer device from a second user device (a provider device), a wireless communications service reply message. At block 340, the method 300 includes obtaining, by the consumer device from the provider device, wireless communications services after the consumer device and the provider device have confirmed at least the price for a service level of communications services to be provided by the second user device to the first user device. The wireless communications service request message can include one of a broadcast (multicast message) message and a unicast message. Example messages that can be used by consumer devices and provider devices to facilitate consumer devices obtaining use of wireless communication services from provider devices are described below. As with the method 200, the obtaining the wireless communications services using the method 300 can include automatically obtaining the wireless communications services without user intervention.

The determining, by the consumer device at block 310, that the consumer device will request wireless communications services from at least one other user device can include determining that a link quality, signal strength or a data rate of a wireless link between the first user device and a network node is less than a threshold. The determining at block 310 can include determining that an amount of data bandwidth available to the first user device is below a threshold. Further, the determining at block 310 can include determining that an amount of charge on a battery for the first user device is less than a threshold.

In the method 300, the one or more service parameters of block 320 can further include mobility information for the consumer device, a time duration during which the consumer device is requesting wireless communications services; an indication whether the consumer device will modify its mobility information to receive offered wireless communication services; and/or one or more security-related parameters or security-related configuration information. The provided time duration can be associated with a specific location and/or the indicated mobility information of the consumer device.

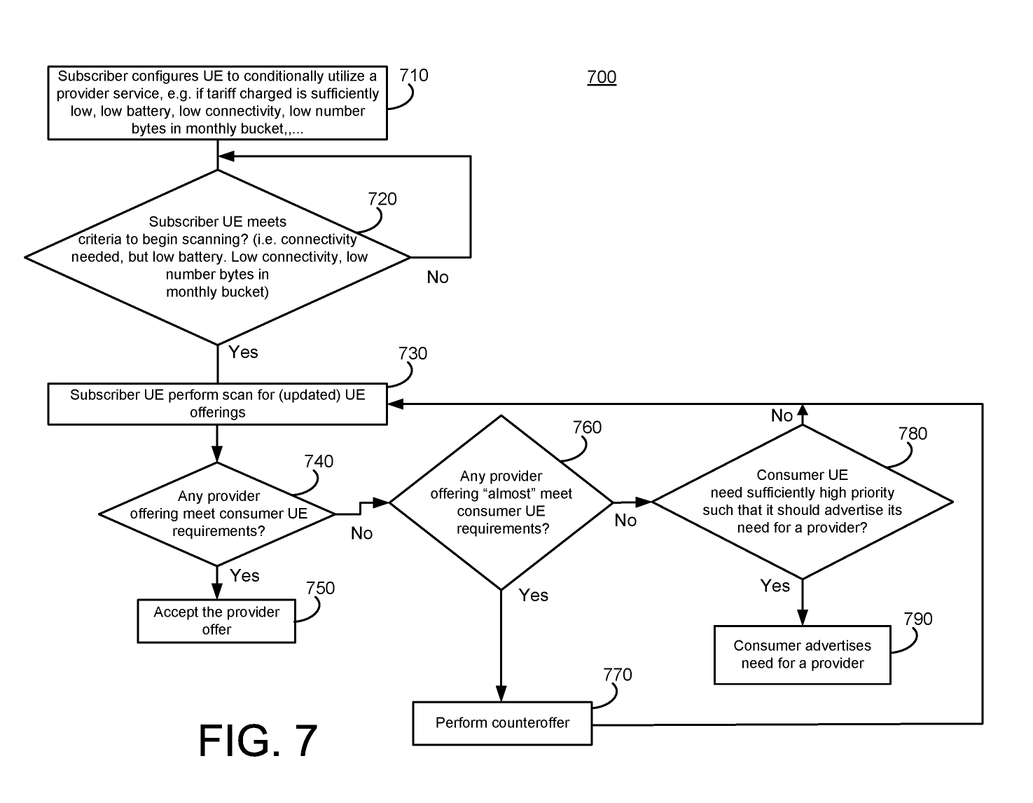

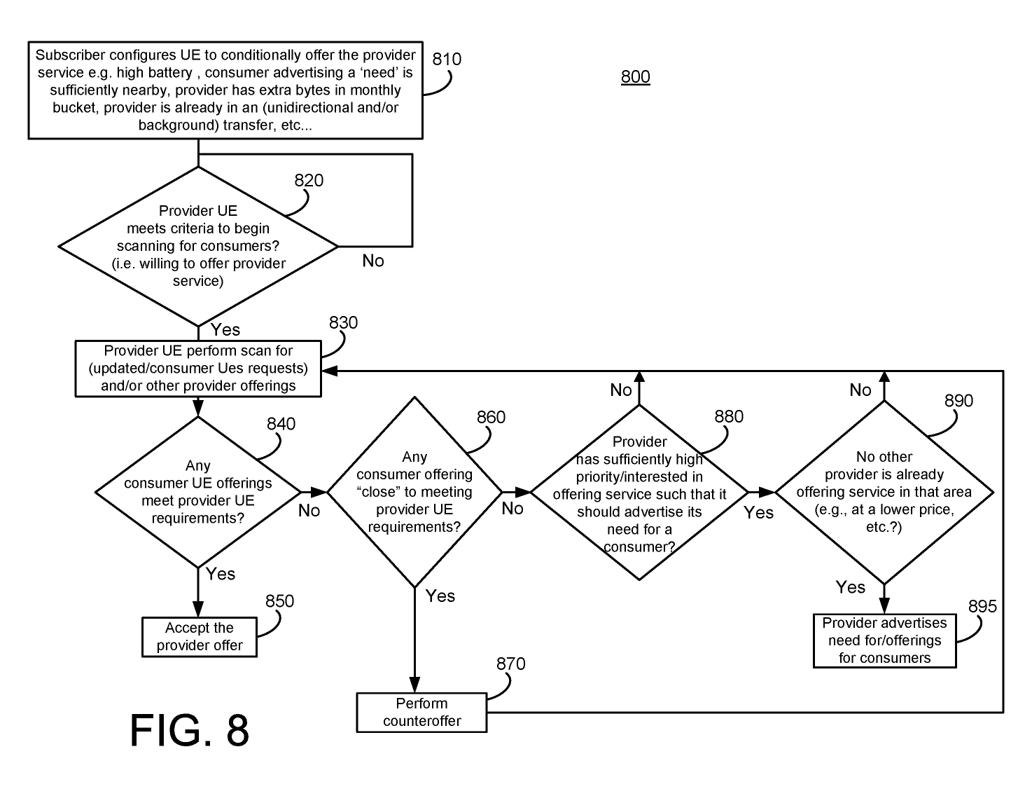

FIG. 4 is a block diagram illustrating a system 400 which can be used to dynamically exchange wireless communication resources between devices (e.g., provider devices and consumer devices), according to an implementation. In one implementation, the system 400 can be implemented in (as part of) a wireless network having a configuration such as the wireless network 130 illustrated in FIG. 1. In other implementations, the system 400 can be implemented in (as part of) wireless networks having other configurations. Further, the system 400 can be used to implement the methods of FIGS. 2A, 2B and 3 discussed above, as well as the methods of FIGS. 7 and 8 discussed below.

As shown in FIG. 4, the system 400 includes a first provider device 410, a second provider device 420, a consumer device 430, an access point 440 and a core network 450. In this example, the consumer device 430 may be a device that has limited resources as compared to provider devices 410 and 420. For instance, the consumer device 430 may be a wearable device (e.g., a watch) that has, as compared to the provider devices 410 and 420, lower antenna power (and fewer antennas), less data transfer speed capability (e.g., may not be 5G and/or LTE capable), limited or unavailable data bandwidth (e.g., out of network, such as when traveling, etc., and/or near or at a monthly data bandwidth limit). The provider devices 410 and 420, as compared with the consumer device 430, may have more antenna power (and more antennas), higher data transfer speed (e.g., may be connected to a 5G and/or LTE network), greater battery capacity and charge, etc.

As also illustrated in FIG. 4, the core network 450 of the system 400 can have access to the Internet 460, a payment server 470 and an application server 480, which can include, e.g., a Virtual Private Network (VPN) termination. As shown in FIG. 4, the core network 450 can access the payment server 470 and the application server 480 directly and/or through (via) the Internet 470. In other implementations, the system 400 can include additional (or fewer) provider devices, additional consumer devices, additional application servers (or other servers, such as content servers, payment servers, etc.).

In the example system 400, using the approaches described herein, the consumer device 430 can obtain wireless communications services from the provider device 410 and/or the provider device 420 to access the application server 480, such as to send data to the application server 480 and/or obtain data from the application server 480. Payment for the wireless communications services can be processed by the payment server 470.

In the system 400, the provider devices 410 and 420 can offer their services using offer messages, such as those described herein. As discussed above, the service parameters offered by each of the provider devices can depend on the service parameters offered by the other provider device. Said another way, the provider devices 480 and 490 may modify their offered service parameters based the other provider device's offered service parameters (e.g., to compete, provide other services, not offer certain services, etc.). The consumer device 430 can respond to such offer messages and the consumer device 430 and the provider device(s) (480 and/or 490) can negotiate service parameters for use of wireless services of one or both of the provider devices 480 and 490, such as using the approaches described herein.

In other instances, the consumer device 430 can request wireless communications services using a request message, such as those described herein. In such an approach, one, or both of the provider devices 480 and 490 can respond to such a request message and wireless communication services can be provided to the consumer device 430 by one or both of the providers devices 480 and 490 once respective agreement(s) on service parameters is(are) reached.

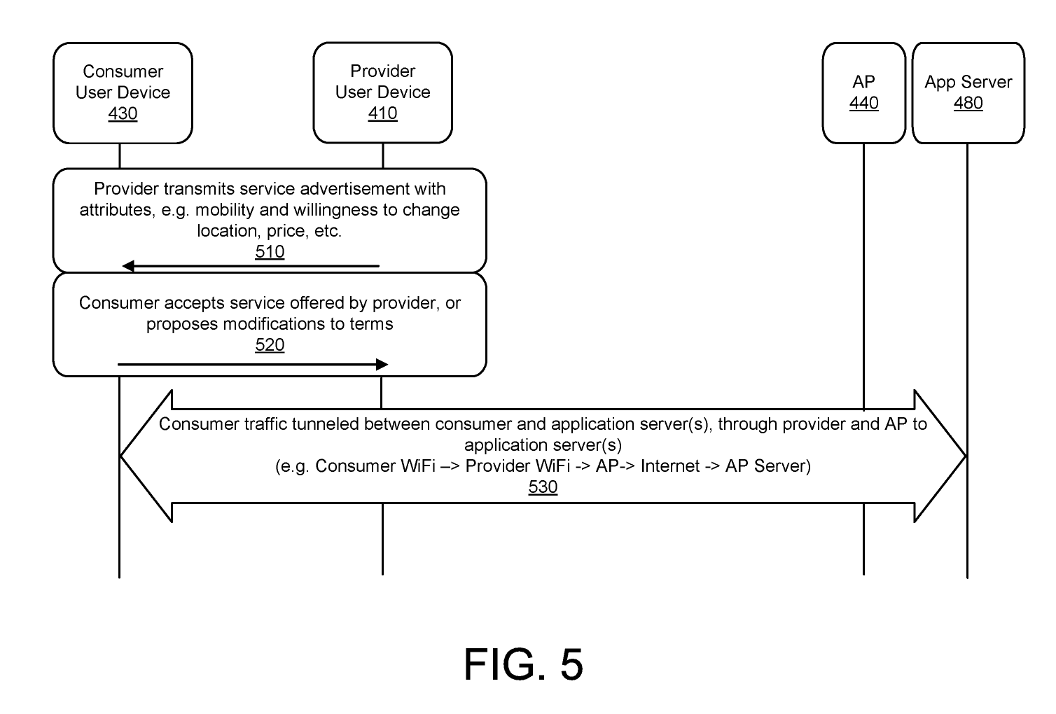

FIG. 5 is a diagram illustrating signaling corresponding with dynamic exchange of wireless communication services initiated by a provider device (provider UE, provider user device, etc.), according to an implementation. The signaling illustrated in FIG. 5 can be used to implement, for example, the method 200 illustrated in FIG. 2 in the system 400. Accordingly, the signaling in FIG. 5 will be described with further reference to the method 200 and the system 400 of FIG. 4. While not shown in FIG. 5, the signaling between the AP 440 and the application server 480 can be communicated via the core network 450 and/or the Internet 470, depending on the particular implementation.

As shown in FIG. 5, operation 510 includes the provider device 410 transmitting a service offer advertisement, such as the wireless communications service offer message of block 230 in the method 200. The service advertisement can include one or more service attributes of the offered wireless communications services, such as those attributes described herein. Operation 520, as shown in FIG. 5, includes the consumer device 430, in response to the service advertisement of operation 510, accepting the services offered by the provider device 410 or proposing modifications to the terms of the offer of the service advertisement of operation 510. In implementations where changes are proposed, operation 520 could include negotiation of service parameters between the consumer device 430 and the provider device 410.

After an agreement on service parameters is reached and accepted, the signaling of FIG. 5 includes, at block 530, tunneling data traffic between the consumer device and the application server 480. In the system 400, such data could be communicated, in an uplink direction, from a WiFi radio (or other radio) of the consumer device 430 to a WiFi radio (or other radio) of the provider device 410, from the provider device 410 to the access point 440 (e.g., via an LTE radio link), from the access point 440 to the core network 450 (not shown in FIG. 5), and from the core network 450 to the application server 480 (either directly or via the Internet 470). For data in a downlink direction, data can follow the same path as for uplink, but in an opposite direction, e.g., from the application server 480 to the consumer device 430.

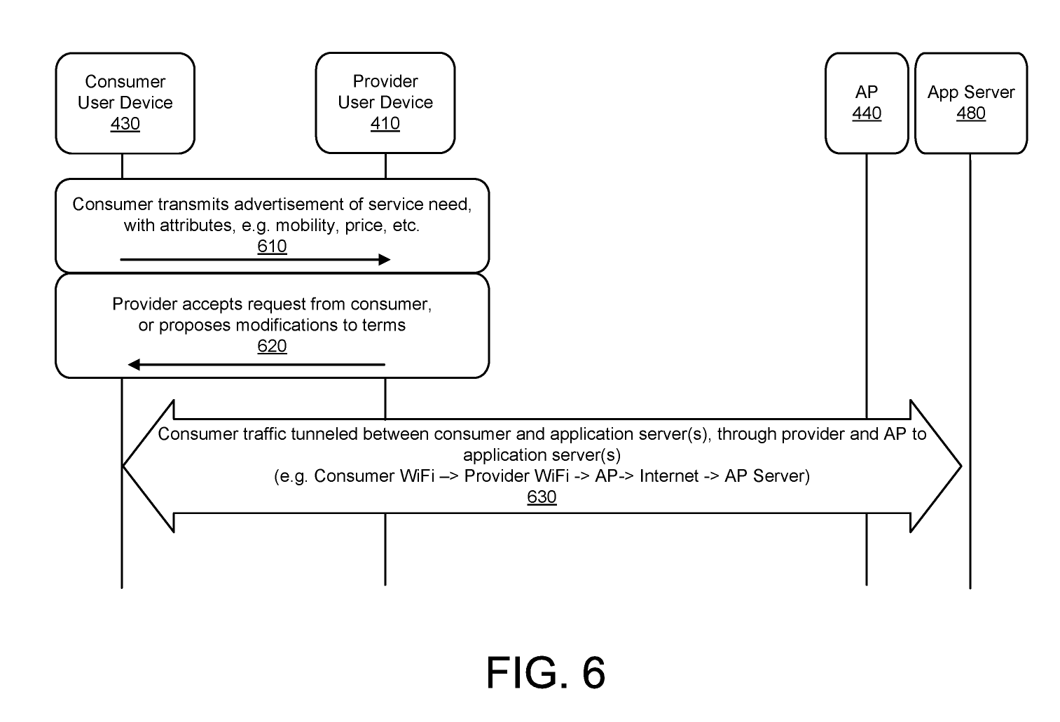

FIG. 6 is a diagram illustrating signaling corresponding with dynamic exchange of wireless communication services initiated by a consumer device (consumer UE, consumer user device, etc.), according to an implementation. The signaling illustrated in FIG. 6 can be used to implement, for example, the method 300 illustrated in FIG. 3 in the system 400. Accordingly, the signaling in FIG. 6 will be described with further reference to the method 300 and the system 400 of FIG. 4. While not shown in FIG. 6, as with the signaling of FIG. 5, the signaling between the AP 440 and the application server 480 in FIG. 6 can be communicated via the core network 450 and/or the Internet 470, depending on the particular implementation.

As shown in FIG. 6, operation 610 includes the consumer device 430 transmitting a service need advertisement, such as the wireless communications service request message of block 320 in the method 300. The service need advertisement can include one or more service attributes of the requested wireless communications services, such as those attributes described herein. Operation 620, as shown in FIG. 6, includes the provider device 430, in response to the service need advertisement of operation 610, accepting the service request of the consumer device 430 or proposing modifications to the terms of the service request of operation 610. In implementations where changes are proposed, operation 620 could include negotiation of service parameters between the consumer device 430 and the provider device 410.

After an agreement on service parameters is reached and accepted, the signaling of FIG. 6, as with the signaling of FIG. 5, includes, at block 630, tunneling data traffic between the consumer device and the application server 480. As noted above with respect to FIG. 5, in the system 400, such data could be communicated, in an uplink direction, from a WiFi radio (or other radio) of the consumer device 430 to a WiFi radio (or other radio) of the provider device 410, from the provider device 410 to the access point 440 (e.g., via an LTE radio link), from the access point 440 to the core network 450 (not shown in FIG. 5.), and from the core network 450 to the application server 480 (either directly or via the Internet 470). For data in a downlink direction, data can follow the same path (as for uplink) in an opposite direction from the application server 480 to the consumer device 430.

The signaling of FIGS. 5 and 6 (and signaling used in implementations the methods of FIGS. 2A, 2B, 3, 7 and 8) can be accomplished in a number of ways. Such signaling can be implemented in stages (or phases). For instance, a first stage of the signaling of FIGS. 5 and 6 (and the methods illustrated by FIGS. 2A, 2B, 3, 7 and 8) can be a discovery stage.

In the example of FIG. 5, the discovery stage can include a provider device providing an indication (e.g., an offer, advertisement, etc.) that the provider device has wireless communications service that are available for use by one or more consumer devices and a consumer device that is looking for wireless communication services responding to the provider device (e.g., with a query or other message). In the example of FIG. 6, the discovery stage can include a consumer device can providing an indication (request) that the consumer device is looking for available wireless communications services from a provider device and a provider device that has available wireless communication services responding to the consumer device (e.g., with a query or other message). Depending on the implementation, the specific wireless communications services being offered or requested may or may not be identified during the discovery stage. In other words, in some implementations, the discovery stage can simply include user devices discovering the presence of other user devices in a network. Alternatively, in other implementations, the discovery state can include a consumer device discovering a provider device offer with one or more service parameters included or a provider device discovering a consumer device request with one or more service parameters included.

After completion of the discovery stage, the signaling of FIGS. 5 and 6 (and signaling used in implementations of the methods of FIGS. 2A, 2B, 3, 7 and 8) can proceed to a service negotiation stage, where the details of the wireless communications services to be provided by a provider device and used by a consumer device can be determined, such as by using the approaches described herein. In certain implementations, information from the discovery stage can be used in the service negotiation phase. For example, information (e.g., service parameters) from an initial offer by a provider device or information from an initial request from a consumer device can be used in the service negotiation stage. After completion of the service negation phase, if an agreement is reached, the wireless communication services corresponding with that agreement can then be provided from the provider device to the user device.

A number of different approaches can be used for implementing the various signaling stages described above. For instance, in certain implementations, 802.11 pre-association signaling can be used. In other implementations, neighborhood area network (NAN) signaling can be used. In still other implementations, other forms of signaling can be used, such as LTE signaling (e.g., LTE overhead messages, such as System Information Block (SIB) messages). In some implementations, hybrid signaling can be used, where different types of signaling are used to implement, for example, different stages of the signaling described above.

In implementations using 802.11 pre-association signaling, the discovery stage can be accomplished through the use of beacons (e.g., broadcast messages indicating a provider device with available services or a consumer device requesting available services), through passive discovery, or through probe requests (e.g., broadcast messages from consumer devices that trigger provider devices to indicate their presence by responding to the broadcast with a unicast probe response message to the consumer device). The service negotiation stage, using 802.11 pre-association signaling, can be accomplished with Generic Advertisement Service (GAS) frames. For instance, service negotiation, e.g., after the discovery stage is completed, can be initiated by a consumer device querying a provider device (e.g., that advertised available services) for a particular service or a list of available services. The provider device can then respond with a unicast GAS message containing the desired information in response to the query.

Tables 1 and 2 below list parameters (information elements) that can be used during the service negotiation stage in implementations using 802.11 pre-association signaling. Table 1 lists example 802.11 Access Network Query Protocol (ANQP) parameters (information elements), while Table 2 lists example Hotspot (HS) 2.0 ANQP Information Elements.

TABLE 1

| Information Element | Description |
|---|---|
| Venue Name | Zero or more venue names associated with |
| | the base station subsystem (BSS) to |
| | support the user's selection |
| Network | A list of authentication types carrying |
| Authentication | additional information like support for |
| Type | online enrollment or redirection URL |
| Roaming | A list of information about the Roaming |
| Consortium | Consortium and/or service switching ports |
| | (SSPs) whose networks are accessible via |
| | this access point (AP) |
| IP Address Type | Information about the availability of IP |
| Availability | address version and type that could be |
| | allocated to the station (STA) after |
| | successful association |
| NAI Realm | A list of network access identifier (NAI) |
| | realms corresponding to SSPs or other |
| | entities whose networks or services are |
| | accessible via this AP; optionally amended |
| | by the list of Extensible Authentication |
| | Protocol (EAP) Method, which are |
| | supported by the SSPs |
| 3GPP Cellular | Cellular information such as network |
| Network | advertisement information e.g., network |
| | codes and country codes to assist a 3GPP |
| | STA in selecting access 3GPP networks. |
| Domain Name | A list of one or more domain names of the |
| | entity operating the IEEE 802.11 access |
| | network. |

TABLE 2

| Information Element | Description |
|---|---|
| HS Query list | A list of identifiers of HS 2.0 ANQP |
| | elements for which the requesting mobile |
| | device is querying in a HS ANQP Query |
| HS Capability list | A list of information/capabilities that has |
| | been configured on an AP. The HS |
| | Capability list element is returned in |
| | response to a GAS Query Request |
| Operator Friendly | Zero or more operator names operating the |
| Name | IEEE 802.11 AN |
| WAN Metrics | Information about the WAN link |
| | connecting a IEEE 802.11 AN and the |
| | Internet |
| Connection | Connection status of the most commonly |
| Capability | used communications protocols and ports |
| NAI Home Realm | Used by the STA to determine if the NAI |
| Query | realms for which it has security credentials |
| | are realms corresponding to SPs or other |
| | entities whose networks or services are |
| | accessible via this BSS |
| Operating Class | Information on the groups of channels in |
| Indication | the frequency band(s) the Wi-Fi access |
| | network is using |

In addition to the information elements listed in Tables 1 and 2, additional information elements, or attributes, can be used (e.g., as part of GAS and ANQP signaling) to implement the approaches described herein. For instance, such additional attributes could include information elements corresponding with the various service parameters for provider devices and consumer devices described herein, such as the service parameters discussed with respect to FIGS. 2A, 2B and 3, for example.

In implementations using NAN signaling, the discovery stage can be accomplished through the use of beacon frames, which can allow user devices connected to a given network to discover the presence of other user devices (e.g., potential provider devices and/or potential consumer devices). A NAN discovery beacon frame can be sent as a broadcast frame (message).

After discovery, once a potential consumer user device knows about the existence (presence) of a potential provider user device, the service negotiation stage can be initiated by the potential consumer user device triggering the potential provider user device to provide an indication of its offered services. For example, the potential consumer user device can trigger the potential provider user device using device using a NAN subscribe message sent from the potential consumer user device to the potential provider user device. The potential provider user device can then respond with a NAN publish message addressed to the potential consumer user device with the desired (requested) information. Alternatively, a potential provider user device can broadcast its service offerings prior to receiving any NAN subscribe message from potential consumer user devices. The potential provider user device can broadcast it service offerings by sending a NAN publish message containing its service offering to a broadcast (multicast) address, which can facilitate discovery and initiation of the service negotiation phase.

As with 802.11 pre-association signaling, a number of service attributes (information elements) can be used in NAN signaling to implement the approaches described herein, where those service attributes (information elements) can include attributes defined in the NAN specification and additional attributes corresponding with the various service parameters for provider devices and consumer devices described herein, such as the service parameters discussed with respect to FIGS. 2A, 2B and 3, for example.

FIG. 7 is a flowchart illustrating a method 700 for requesting and/or obtaining use of wireless communications services by one user device from another user device, according to an implementation. The method 700 can be implemented in the network 400. For example, the method 700 can be implemented by the consumer device 430 to identify and obtain wireless communication services from the provider devices 410, 420. For clarity, the provider device 410 will be referenced in the discussion of the method 700 below.

As shown in FIG. 7, the method 700, at block 710, can include a subscriber (user) configuring a consumer UE (consumer device 430) with one or more service parameters that can be included in a service request message. Such parameters can include a cost (tariff parameter), a battery level parameter, a connectivity parameter, a data bandwidth availability parameter, etc. At block 720, the consumer UE can determine whether to look (scan) for available wireless communications services of a provider UE (such as provider device 410), e.g., based on the configuration information of block 710. If the consumer UE determines, at block 720, that it should not look for available services, the method 700 can remain at block 720 until the consumer UE determines, e.g., based on the configuration information of block 710, that the consumer UE should look for available wireless communications services from a provider UE.

If the consumer UE determines, at block 720, that it should look for available wireless communication services, the method 700 can continue to block 730 and the consumer UE can scan for service offers from provider UEs. At block 740, a determination can be made as to whether there are any service offers from provider UEs that match the service parameters (e.g., block 710) of the consumer UE. If a matching service offer is identified at block 740, the method 700 can proceed to block 750 and the consumer UE can accept the offer and begin using the associated wireless communication services.

If, however, a determination is made at block 740 that there are no offers from provider UEs that match the service parameters of the consumer UE, the method 700 can proceed to block 760. At block 760, a determination can be made as to whether there are any service offers from provider UEs that are “close” to or “almost” match the desired service parameters of the consumer UE. This determination can depend on the particular embodiment and may depend, at least in part, on the configuration information of block 710. For instance, the determination of block 760 can depend on respective indications of importance of one or more service parameters included in the configuration information of block 710, such as price for a given service level.

If it is determined, at block 760, that there is a service offer from a provider UE that is close to, or almost matches the service parameters of the consumer UE, the consumer UE can, at block 770, send a response message including a counteroffer that modifies one or more parameters of the service offer identified at block 760. The method 700 can then return to block 730 and the consumer UE can scan for service offers from provider UEs that match the counteroffer (e.g., check if the counteroffer was accepted by the provider UE associated with the service offer that was identified at block 760).

If a service offer is not identified at block 760, the method 700 can continue to block 780 where a determination can be made by the consumer UE as to a priority of obtaining wireless communication services from a provider UE. As with the determination at block 760, the determination at block 780 can depend on the particular embodiment and may depend, at least in part, on the configuration information of block 710. For instance, the determination of block 780 can depend (as the determination at block 760) on respective indications of importance of one or more service parameters included in the configuration information of block 710.

For example, battery level may be indicated as critical if below a threshold. In this example, if the battery level of the consumer UE falls below the indicated threshold, a determination can be made at block 780 that obtaining wireless communications resources from a provider UE is a high priority. The method 700 can proceed to block 790, and the consumer UE can transmit a service need advertisement, such as using the approaches described herein. If, however, it is determined, at block 780, that obtaining wireless services from a provider UE is not a priority, the method 700 can return to block 730, and the consumer UE can continue to scan for update service offers that match its service parameters (e.g., as defined by the configuration information of block 710).

FIG. 8 is a flowchart illustrating a method 800 for offering and/or providing use of wireless communications services of one user device to another user device, according to an implementation. The method 800 can be implemented in the network 400. For example, the method 800 can be implemented by the provider device 410 (or the provider device 420) to offer and provide wireless communication services to the consumer device 430.

As shown in FIG. 8, the method 800, at block 810, can include a subscriber (user) configuring a provider UE (provider device 410) with one or more service parameters that can be included in a service offer message. Such parameters can include a cost (tariff parameter), a battery level parameter, a connectivity parameter, a data bandwidth parameter, etc. At block 820, the provider UE can determine whether to offer wireless communications services to consumer UEs (such as consumer device 430), e.g., based on the configuration information of block 810. If the provider UE determines, at block 820, that it will not offer wireless communication services to consumer UEs, the method 800 can remain at block 820 until the provider UE determines, e.g., based on the configuration information of block 810, that it should look for consumer UEs that are looking for wireless communication services.

If the provider UE determines, at block 820, that it should look for consumer UEs looking for available wireless communication services, the method 800 can continue to block 830 and the provider UE can scan for service request and/or service offers from other provider UEs. At block 840, a determination can be made as to whether there are any service requests from consumer UEs that match the service parameters (e.g., block 810) of the provider UE. If a matching service request is identified at block 840, the method 800 can proceed to block 850 and the consumer UE can (e.g., in response to a query from the provider UE) accept the provider's UE wireless communications services offer and the provider UE can begin providing the associated wireless communication services to the corresponding consumer UE.

If, however, a determination is made at block 840 that there are no service requests from consumer UEs that match the service parameters of the provider UE, the method 800 can proceed to block 860. At block 860, a determination can be made as to whether there are any service requests from consumer UEs that are “close” to or “almost” match the desired service parameters of the provider UE. As with the determination at block 760 of the method 700, the determination at block 860 can depend on the particular embodiment and may depend, at least in part, on the configuration information of block 810. For instance, the determination of block 860 can depend on respective indications of importance of one or more service parameters included in the configuration information of block 810 or for service parameters of a given service request, such as price for a given service level.

If it is determined, at block 860, that there is a service request from a consumer UE that is close to, or almost matches the service parameters of the provider UE, the provider UE can, at block 870, send an offer message including a counteroffer that modifies one or more parameters of the service request identified at block 860. The method 800 can then return to block 830 and the provider UE can scan for service requests from consumer UEs that match the counteroffer (e.g., check if the counteroffer was accepted by the consumer UE associated with the service request that was identified at block 860).

If a service offer is not identified at block 860, the method 800 can continue to block 880 where a determination can be made by the provider UE as to a priority of providing wireless communication services to one or more consumer UEs. As with the determination at block 860, the determination at block 880 can depend on the particular embodiment and may depend, at least in part, on the configuration information of block 810. For instance, the determination of block 880 can depend (as the determination at block 860) on respective indications of importance of one or more service parameters included in the configuration information of block 810.

For example, battery level may be indicated as a critical factor in determining whether to provide wireless communication services. For instance, if a battery level of the provider UE is above a threshold, the provider UE may determine, at block 880, that providing wireless communications resources to consumer UEs is a high priority. The method 800 can proceed to block 890, where the provider UE can determine if other provider UEs are offering the same wireless services in the same area (e.g., at a lower price). If there are no other provider UEs offering the same services, the method 800 may continue to block 895 and the provider UE can transmit a service offer advertisement, such as using the approaches described herein.

If, however, at block 880, it is determined by the provider UE that providing wireless services to one or more consumer UEs is not a priority, the method 800 can return to block 830, and the provider UE can continue to scan for updated service requests (from consumer UEs) that match its service parameters (e.g., as defined by the configuration information of block 810).

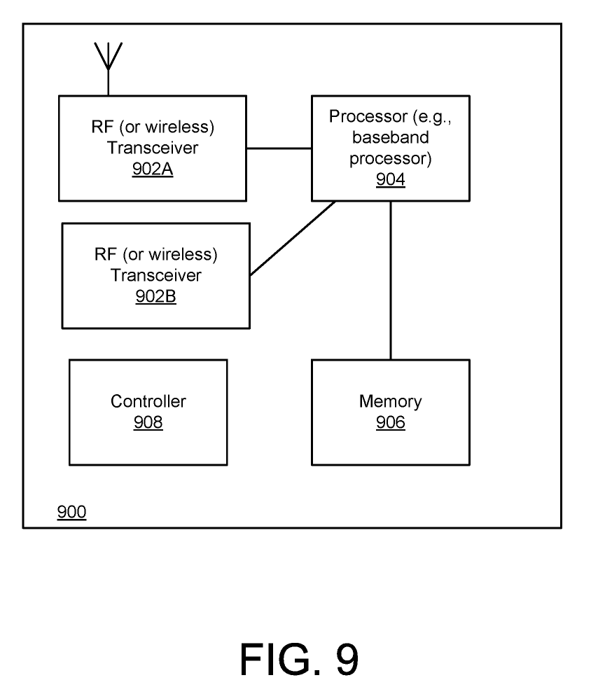

FIG. 9 is a block diagram of a wireless station (e.g., AP or user device) 900 according to an example implementation. The wireless station 900 may include, for example, one or two RF (radio frequency) or wireless transceivers 902A, 902B, where each wireless transceiver includes a transmitter to transmit signals and a receiver to receive signals. The wireless station also includes a processor or control unit/entity (controller) 904 to execute instructions or software and control transmission and receptions of signals, and a memory 906 to store data and/or instructions.

Processor 904 may also make decisions or determinations, generate frames, packets or messages for transmission, decode received frames or messages for further processing, and other tasks or functions described herein. Processor 904, which may be a baseband processor, for example, may generate messages, packets, frames or other signals for transmission via wireless transceiver 902 (902A or 902B). Processor 904 may control transmission of signals or messages over a wireless network, and may control the reception of signals or messages, etc., via a wireless network (e.g., after being down-converted by wireless transceiver 902, for example). Processor 904 may be programmable and capable of executing software or other instructions stored in memory or on other computer media to perform the various tasks and functions described above, such as one or more of the tasks or methods described above. Processor 904 may be (or may include), for example, hardware, programmable logic, a programmable processor that executes software or firmware, and/or any combination of these. Using other terminology, processor 904 and transceiver 902 together may be considered as a wireless transmitter/receiver system, for example.

In addition, referring to FIG. 9, a controller (or processor) 908 may execute software and instructions, and may provide overall control for the station 900, and may provide control for other systems not shown in FIG. 9, such as controlling input/output devices (e.g., display, keypad), and/or may execute software for one or more applications that may be provided on wireless station 900, such as, for example, an email program, audio/video applications, a word processor, a Voice over IP application, or other application or software.

In addition, a storage medium may be provided that includes stored instructions, which when executed by a controller or processor may result in the processor 904, or other controller or processor, performing one or more of the functions or tasks described above.

According to another example implementation, RF or wireless transceiver(s) 902A/902B may receive signals or data and/or transmit or send signals or data. Processor 904 (and possibly transceivers 902A/902B) may control the RF or wireless transceiver 902A or 902B to receive, send, broadcast or transmit signals or data.

In a general aspect, a method can include determining, by a first user device in a wireless network, that the first user device will offer wireless communications services to one or more other user devices; determining, by the first user device, mobility information for the first user device; and sending, by the first user device, a wireless communications service offer message that offers to provide a wireless communications service to other user devices. The wireless communications service offer message can indicate one or more service parameters including at least the mobility information of the first user device and a price for one or more service levels of wireless communications services. The method can further include providing, by the first user device, wireless communications services to a second user device after the first user device and the second user device have confirmed at least the price for a service level of communications services to be provided to the second user device.

Implementations can include one or more of the following details. For example, the determining, by the first user device, that the first user device will offer wireless communications services to one or more other user devices can include at least one of confirming that the first user device has a connection established to a network node; confirming that the first user device is performing a transfer with the network node; confirming that a link quality, signal strength or a data rate of a wireless link between the first user device and the network node is greater than a threshold; and determining that an amount of charge on a battery for the first user device is greater than a threshold.

The mobility information can include at least one of a location of the first user device; an expected duration of time the first user device will remain at the location; a speed of the first user device; a mobility state of the first user device; a direction of travel or route of the first user device; and a mode of travel of the first user device.

The service level for at least one of uplink communications and downlink communications can be indicated by at least one of a data rate; a quality of service (QoS); and a link quality.

The wireless communications services can include at least one of forwarding data received from the second user device to a network node; and forwarding data received from the network node to the second user device.

The providing wireless communication services can include receiving, by the first user device from the second user device, a wireless communications reply message that indicates that the second user device accepts the service parameters indicated by the wireless communications service offer message; establishing, by the first user device, a connection between the first user device and the second user device; and providing, by the first user device, the wireless communications services, including relaying, by the first user device via wireless communications, data between the second user device and a network node in at least one of an uplink direction and a downlink direction. The wireless communications reply message can indicate a selected service level for the communications services of a plurality of service levels indicated by the wireless communications service offer message.

The one or more service parameters can include one or more of a time duration during which the first user device is offering wireless communications services; an indication whether the first user device will modify its mobility information to provide the offered wireless communication services; an indication of whether the first user device can cache information for the second user device; an indication that the offered wireless communications services are associated with a transportation service; and one or more security-related parameters or security-related configuration information. The one or more service parameters can be based on a wireless communications service offer message from a third user device.

The one or more service levels of wireless communications services can include a first bit rate that can be provided during a first time interval and a second bit rate that can be provided during a second time interval, the second time interval being a different time interval than the first time interval.

The providing wireless communication services can include receiving, by the first user device from the second user device, a wireless communications service reply message that indicates a new service parameter or a change to one of the service parameters indicated by the wireless communication service offer message; sending, by the first user device to the second user device, a wireless communications service confirmation message that indicates that the first user device will provide the wireless communication service to the second user device in accordance with the service parameters indicated by the wireless communications service reply message; and providing, by the first user device, the wireless communications services to the second user device.

The wireless communications service offer message can include one of a broadcast message and a unicast message. The wireless communications service offer message can be responsive to a query message from the second user device.

The providing the wireless communications services to the second user device can include automatically providing the wireless communications services to the second user device without user intervention.

The method can include verifying, at least once during the providing the wireless communications services to the second user device, whether a payment for at least a portion of the wireless communications services provided to the second user device has been made; and, if the payment has not been made, ceasing to provide the wireless communications services to the second user device. The method can include, if the payment has been made, continuing to provide the wireless communications services.

In another general aspect, a method can include sending, by a first user device in a wireless network, a wireless communications service request message that requests wireless communications service from another user device. The wireless communications service request message can indicate one or more service parameters including at least a price for one or more service levels. The method can also include receiving, by the first user device from a second user device, a wireless communications service reply message and obtaining, by the first user device from the second user device, wireless communications services after the first user device and the second user device have confirmed at least the price for a service level of communications services to be provided by the second user device to the first user device.

Implementations can include one or more of the following features. For example, the wireless communications service request message includes one of a broadcast message and a unicast message.

The one or more service parameters can include one or more of a time duration during which the first user device is requesting wireless communications services; an indication whether the first user device will modify its mobility information to receive offered wireless communication services; and one or more security-related parameters or security-related configuration information.

The method can include, prior to sending the wireless communications service request message, determining, by the first user device, that the first user device will request wireless communications services from at least one other user device. The determining, by the first user device, that the first user device will request wireless communications services from at least one other user device can include at least one of determining that a link quality, signal strength or a data rate of a wireless link between the first user device and a network node is less than a threshold; determining that an amount of data bandwidth available to the first user device is below a threshold; and determining that an amount of charge on a battery for the first user device is less than a threshold.

The one or more service parameters can include one or more of; mobility information for the first user device; a time duration during which the first user device is requesting wireless communications services; and one or more security-related parameters or security-related configuration information.

The obtaining the wireless communications services can include automatically obtaining the wireless communications services without user intervention.

In another general aspect, a wireless device can include at least one processor and at least one memory including computer instructions. The instructions, when executed by the at least one processor, can cause the wireless device to determine that the wireless device will offer wireless communications services to one or more other wireless devices; determine mobility information for the wireless device; and send a wireless communications service offer message that offers to provide a wireless communications service to the one or more other wireless devices. The wireless communications service offer message can indicate one or more service parameters including at least the mobility information of the wireless device and a price for one or more service levels of wireless communications services. The instructions, when executed by the at least one processor, can further cause the wireless device to provide wireless communications services to a wireless device of the one or more other wireless devices after the wireless device and the wireless device of the one or more other wireless devices have confirmed at least the price for a service level of communications services to be provided to the wireless device of the one or more other wireless devices.

In another general aspect, a wireless device can include at least one processor and at least one memory including computer instructions. The instructions, when executed by the at least one processor, can cause the wireless device to send, in a wireless network, a wireless communications service request message that requests wireless communications service from another wireless device. The wireless communications service request message can indicate one or more service parameters including at least a price for one or more service levels. The instructions, when executed by the at least one processor, can further cause the wireless device to receive, from the another wireless device, a wireless communications service reply message; and obtain, from the another wireless device, wireless communications services after the wireless device and the another wireless device have confirmed at least the price for a service level of communications services to be provided by the another wireless device to the wireless device.

The embodiments are not, however, restricted to the system that is given as an example, but a person skilled in the art may apply the solution to other communication systems. Another example of a suitable communications system is the 5G concept. It is assumed that network architecture in 5G will be quite similar to that of the LTE-advanced. 5G is likely to use multiple input—multiple output (MIMO) antennas, many more base stations or nodes than the LTE (a so-called small cell concept), including macro sites operating in co-operation with smaller stations and perhaps also employing a variety of radio technologies for better coverage and enhanced data rates.

It should be appreciated that future networks will most probably utilize network functions virtualization (NFV) which is a network architecture concept that proposes virtualizing network node functions into “building blocks” or entities that may be operationally connected or linked together to provide services. A virtualized network function (VNF) may comprise one or more virtual machines running computer program codes using standard or general type servers instead of customized hardware. Cloud computing or data storage may also be utilized. In radio communications this may mean node operations may be carried out, at least partly, in a server, host or node operationally coupled to a remote radio head. It is also possible that node operations will be distributed among a plurality of servers, nodes or hosts. It should also be understood that the distribution of labor between core network operations and base station operations may differ from that of the LTE or even be non-existent.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device or in a propagated signal, for execution by, or to control the operation of, a data processing apparatus, e.g., a programmable processor, a computer, or multiple computers. Implementations may also be provided on a computer readable medium or computer readable storage medium, which may be a non-transitory medium. Implementations of the various techniques may also include implementations provided via transitory signals or media, and/or programs and/or software implementations that are downloadable via the Internet or other network(s), either wired networks and/or wireless networks. In addition, implementations may be provided via machine type communications (MTC), and also via an Internet of Things (JOT).

The computer program may be in source code form, object code form, or in some intermediate form, and it may be stored in some sort of carrier, distribution medium, or computer readable medium, which may be any entity or device capable of carrying the program. Such carriers include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers.

Furthermore, implementations of the various techniques described herein may use a cyber-physical system (CPS) (a system of collaborating computational elements controlling physical entities). CPS may enable the implementation and exploitation of massive amounts of interconnected ICT devices (sensors, actuators, processors microcontrollers, . . . ) embedded in physical objects at different locations. Mobile cyber physical systems, in which the physical system in question has inherent mobility, are a subcategory of cyber-physical systems. Examples of mobile physical systems include mobile robotics and electronics transported by humans or animals. The rise in popularity of smartphones has increased interest in the area of mobile cyber-physical systems. Therefore, various implementations of techniques described herein may be provided via one or more of these technologies.

A computer program, such as the computer program(s) described above, can be written in any form of programming language, including compiled or interpreted languages, and can be deployed in any form, including as a stand-alone program or as a module, component, subroutine, or other unit or part of it suitable for use in a computing environment. A computer program can be deployed to be executed on one computer or on multiple computers at one site or distributed across multiple sites and interconnected by a communication network.

Method steps may be performed by one or more programmable processors executing a computer program or computer program portions to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer, chip or chipset. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry.

To provide for interaction with a user, implementations may be implemented on a computer having a display device, e.g., a cathode ray tube (CRT) or liquid crystal display (LCD) monitor, for displaying information to the user and a user interface, such as a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the various embodiments.

1. A method comprising:
determining, by a first user device in a wireless network, that the first user device will offer wireless communications services to one or more other user devices;
determining, by the first user device, mobility information for the first user device;
sending, by the first user device, a wireless communications service offer message that offers to provide a wireless communications service to other user devices, the wireless communications service offer message indicating one or more service parameters including at least the mobility information of the first user device and a price for one or more service levels of wireless communications services; and
providing, by the first user device, wireless communications services to a second user device after the first user device and the second user device have confirmed at least the price for a service level of communications services to be provided to the second user device.

2. The method of claim 1, wherein the determining, by the first user device, that the first user device will offer wireless communications services to one or more other user devices includes at least one of:
confirming that the first user device has a connection established to a network node;
confirming that the first user device is performing a transfer with the network node;
confirming that a link quality, signal strength or a data rate of a wireless link between the first user device and the network node is greater than a threshold; and
determining that an amount of charge on a battery for the first user device is greater than a threshold.

3. The method of claim 1, wherein the mobility information includes at least one of:
a location of the first user device;
an expected duration of time the first user device will remain at the location;
a speed of the first user device;
a mobility state of the first user device;
a direction of travel or route of the first user device; and
a mode of travel of the first user device.

4. The method of claim 1, wherein the service level for at least one of uplink communications and downlink communications, is indicated by at least one of:
a data rate;
a quality of service (QoS); and
a link quality.

5. The method of claim 1, wherein the wireless communications services include at least one of:
forwarding data received from the second user device to a network node;
forwarding data received from the network node to the second user device.

6. The method of claim 1, wherein the providing includes:
receiving, by the first user device from the second user device, a wireless communications reply message that indicates that the second user device accepts the service parameters indicated by the wireless communications service offer message;
establishing, by the first user device, a connection between the first user device and the second user device; and
providing, by the first user device, the wireless communications services, including relaying, by the first user device via wireless communications, data between the second user device and a network node in at least one of an uplink direction and a downlink direction.

7. The method of claim 6, wherein the wireless communications reply message indicates a selected service level for the communications services of a plurality of service levels indicated by the wireless communications service offer message.

8. The method of claim 1, wherein the one or more service parameters further include one or more of:
a time duration during which the first user device is offering wireless communications services;
an indication whether the first user device will modify its mobility information to provide the offered wireless communication services;
an indication of whether the first user device can cache information for the second user device;
an indication that the offered wireless communications services are associated with a transportation service; and
one or more security-related parameters or security-related configuration information.

9. The method of claim 1, wherein the one or more service levels of wireless communications services include:
a first bit rate that can be provided during a first time interval; and
a second bit rate that can be provided during a second time interval, the second time interval being a different time interval than the first time interval.

10. The method of claim 1, wherein the providing includes:
receiving, by the first user device from the second user device, a wireless communications service reply message that indicates a new service parameter or a change to one of the service parameters indicated by the wireless communication service offer message;
sending, by the first user device to the second user device, a wireless communications service confirmation message that indicates that the first user device will provide the wireless communication service to the second user device in accordance with the service parameters indicated by the wireless communications service reply message; and
providing, by the first user device, the wireless communications services to the second user device.

11. The method of claim 1, wherein the wireless communications service offer message is responsive to a query message from the second user device.

12. The method of claim 1, wherein the providing the wireless communications services to the second user device includes automatically providing the wireless communications services to the second user device without user intervention.

13. The method of claim 1, further comprising:
verifying, at least once during the providing the wireless communications services to the second user device, whether a payment for at least a portion of the wireless communications services provided to the second user device has been made; and
if the payment has not been made, ceasing to provide the wireless communications services to the second user device.

14. The method of claim 13, further comprising, if the payment has been made, continuing to provide the wireless communications services.

15-19. (canceled)

20. A wireless device comprising at least one processor and at least one memory including computer instructions, when executed by the at least one processor, cause the wireless device to:
determine that the wireless device will offer wireless communications services to one or more other wireless devices;
determine mobility information for the wireless device;
send a wireless communications service offer message that offers to provide a wireless communications service to the one or more other wireless devices, the wireless communications service offer message indicating one or more service parameters including at least the mobility information of the wireless device and a price for one or more service levels of wireless communications services; and
providing wireless communications services to a wireless device of the one or more other wireless devices after the wireless device and the wireless device of the one or more other wireless devices have confirmed at least the price for a service level of communications services to be provided to the wireless device of the one or more other wireless devices.

21. The wireless device of claim 20, wherein causing the wireless device to determine, by the first user device, that the first user device will offer wireless communications services to one or more other user devices comprises causing the wireless device to perform at least one of:
confirm that the first user device has a connection established to a network node;
confirm that the first user device is performing a transfer with the network node;
confirm that a link quality, signal strength or a data rate of a wireless link between the first user device and the network node is greater than a threshold; and
determine that an amount of charge on a battery for the first user device is greater than a threshold.

22. The wireless device of claim 20, wherein causing the wireless device to provide comprises causing the wireless device to:
receive, by the first user device from the second user device, a wireless communications reply message that indicates that the second user device accepts the service parameters indicated by the wireless communications service offer message;
establish, by the first user device, a connection between the first user device and the second user device; and
provide, by the first user device, the wireless communications services, including relaying, by the first user device via wireless communications, data between the second user device and a network node in at least one of an uplink direction and a downlink direction.

23. The wireless device of claim 20, wherein the one or more service parameters further include one or more of:
a time duration during which the first user device is offering wireless communications services;
an indication whether the first user device will modify its mobility information to provide the offered wireless communication services;
an indication of whether the first user device can cache information for the second user device;
an indication that the offered wireless communications services are associated with a transportation service; and
one or more security-related parameters or security-related configuration information.

24. The wireless device of claim 20, wherein causing the wireless device to provide comprises causing the wireless device to:
receive, by the first user device from the second user device, a wireless communications service reply message that indicates a new service parameter or a change to one of the service parameters indicated by the wireless communication service offer message;
send, by the first user device to the second user device, a wireless communications service confirmation message that indicates that the first user device will provide the wireless communication service to the second user device in accordance with the service parameters indicated by the wireless communications service reply message; and
provide, by the first user device, the wireless communications services to the second user device.

25. The wireless device of claim 20, and further causing the wireless device to:
verify, at least once during the providing the wireless communications services to the second user device, whether a payment for at least a portion of the wireless communications services provided to the second user device has been made; and
if the payment has not been made, ceasing to provide the wireless communications services to the second user device.
